(19) United States
(12) Patent Application Publication
(10) Pub. No.: US 2005/0050740 A1
(43) Pub. Date: Mar. 10, 2005

(54) Hole puncher with quick disasssembling structure for changing cutters

(76) Inventor: Yu-Chiang Lin, Taichung City (TW)

Correspondence Address: CHARLES E. BAXLEY, ESQUIRE, THIRD FLOOR, 90 JOHN STREET, NEW YORK, NY, 10038, US

(21) Appl. No.: 10/655,989

(22) Filed: Sep. 5, 2003

(51) Int. Cl. B26F 1/00

(52) U.S. Cl. 30/363; 30/358

(57) ABSTRACT

A hole puncher with a quick disassembling structure for changing cutters comprises a pair of corresponsive extendible tongs handles, at least two cutters, and two quick disassembling structures; wherein each quick disassembling structure having an elastic clamp which is a small bent wire comprised of a fixed section, a latch section, and a control section, and such elastic clamp is mounted on the backside of the tip of the puncher by a fixture, and the cutter passing through a cutter hole is fixed by the latch section.

### BACKGROUND OF THE INVENTION

1. Field of the Invention

The present invention relates to a hole puncher, more particularly pertains to a hole puncher with a quick disassembling structure that allows users to change cutters easily and quickly.

2. Description of the Related Art

The traditional structure of a hole puncher as shown in FIGS. 1 and 2 generally comprises a pair of corresponding extendible tong members, and the tong member (hereinafter referred to as “Cutter” in the specification) is a member reinforced by wrapping and soldering and has independent components such as screw hole, hole cutter, anvil, tack anvil member, and tack clipping member, etc. and also has screw threads for securing the screws on the reinforced member.

The hole cutter working together with the anvil maximizes the punching function; the tack anvil member working together with the tack clipping member fixes a tack in the hole. The disposition of screw hole and screw thread makes the manufacture of hole puncher more complicated, and it takes more time and efforts to replace the cutter since repeated rotations of the cutter are required.

Further, since the distance between the tips of the tong is very close, it is preferable to tighten or loosen the cutter by hands. If the cutter is not securely tightened, the cutter will be unstable during the hole punching or tacking process, and thus easily causing a defective manufacture or a deformation of the screw threads due to improper external forces, which will affect the replacement and fixture of the cutter.

### SUMMARY OF THE INVENTION

The primary objective of the present invention is to improve the problems of the traditional screw thread technology such as taking up more time and efforts to replace cutters, the cutter not able to be tightened easily, having manufacturing defectives on punching holes or tacking easily, the screw thread being deformed by improper external forces, and the like. This invention uses a quick disassembling structure to make the replacement of cutters for the hole puncher simpler, easier, and quicker. The cutter is fixed in an elastic clamp, and when the tong members are correspondingly clipped to the punch holes or tacking for the manufacturing, the blocking section of the cutter can press against the wall at the tip of the tong and obtain a stable support, so that the cutter can stably punch holes or stamp tacks, and thus greatly reducing the probability of causing defects or mistakes.

The technology to accomplish the foregoing objective of the present invention is described as follows:
A hole puncher with quick disassembling structure for replacing cutters having a pair of corresponding extendible tong members and a plurality of cutters of different sizes and functions, and such hole puncher having a quick disassembling structure, and such quick assembling structure comprises:
an elastic clamp, being an integrally bent metal bar and forming a fixed section with parallel bars proximate the bent position, and a latch section being further extended outward from the bar in the opposite direction, and a control section being further extended vertically from the latch section;
a latch hole, disposed at the tip of the tong member, for fixing the fixed section of the elastic clamp by a fixture at the backside of the tip of the tong member;
a cutter hole, disposed at the tip of the tong member corresponding to the position of the latch section of the elastic clamp;
a fixed section, disposed on the cutter, and having a latch groove surrounding the fixed section such that the fixed section being embedded into the latch hole, and the latch section of the elastic clamp being latched into the latch groove to fix the cutter to the tip of the tong member, and the diameter of the fixed section of the cutter being smaller than the working section, so that the interface of two sections defining a blocking surface.

### BRIEF DESCRIPTION OF THE DRAWINGS

FIG. 1 is a perspective diagram of the hole puncher, tack anvil member, and tack clipping member according to the prior art.

FIG. 2 is a perspective diagram of the assembled hole puncher, hole cutter, and anvil according to the prior art.

FIG. 3A is a perspective diagram of the disassembled parts of the structure of the hole puncher with quick disassembling structure according to a preferred embodiment of this invention.

FIG. 3B is a perspective diagram of the assembled structure of the disassembled parts as shown in FIG. 3A.

FIG. 4 is a side-view diagram of the section as indicated by the arrows in FIG. 3B.

FIG. 5A is a cross-sectional diagram of the section 5A-5A as shown in FIG. 3B.

FIG. 5B is an illustrative diagram of the movement as shown in FIG. 5A.

FIG. 6A is a side-view diagram of the cutter and anvil according to this invention.

FIG. 6B is a side-view diagram of the cutter and cutter hole according to this invention.

FIG. 7A is a side-view diagram of the cutter and tack anvil member according to this invention.

FIG. 7B is a side-view diagram of the cutter and the tack clipping member of this invention.

FIG. 8 is perspective diagram of the disassembled parts of the structure according to the second preferred embodiment of this invention.

FIG. 9A is a side-view diagram of the section indicated by the arrow 9A as shown in FIG. 8.

FIG. 9B is an illustrative diagram of the movement as shown in FIG. 9A.

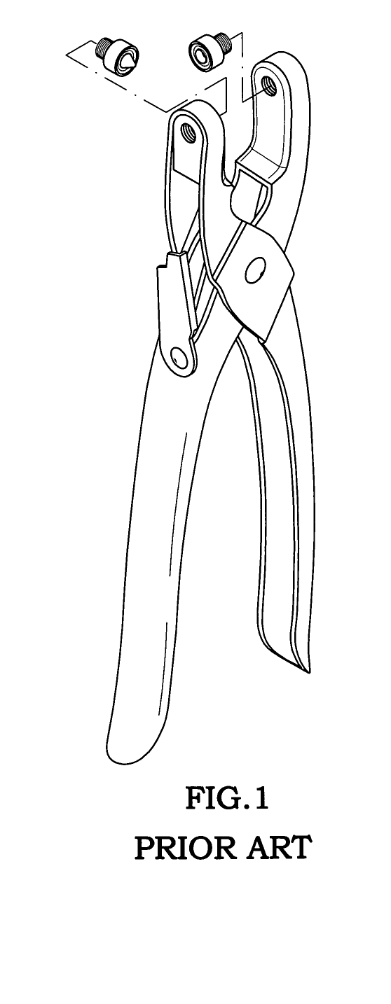

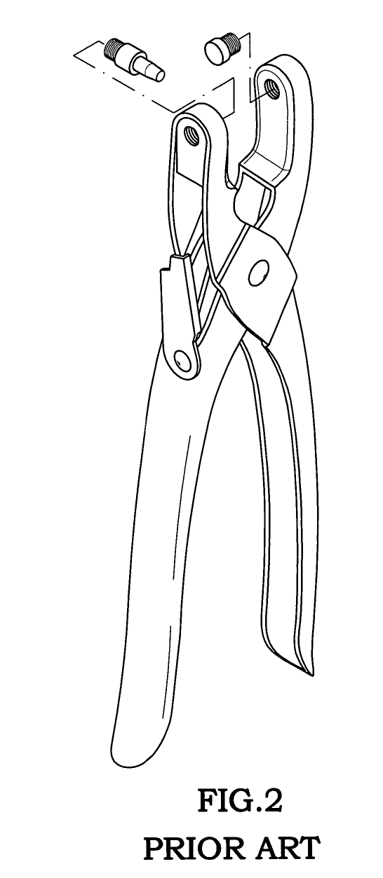

### DETAILED DESCRIPTION OF THE PREFERRED EMBODIMENTS

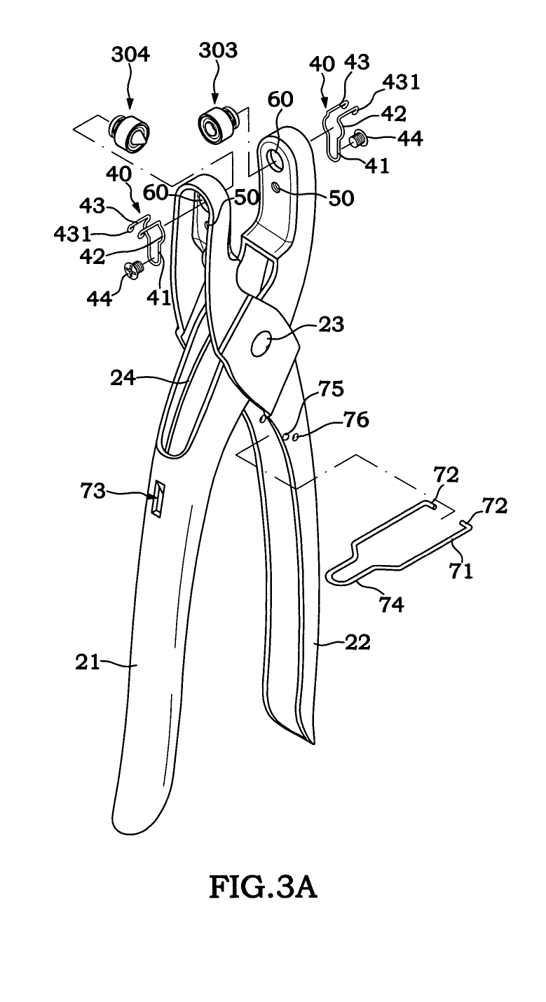

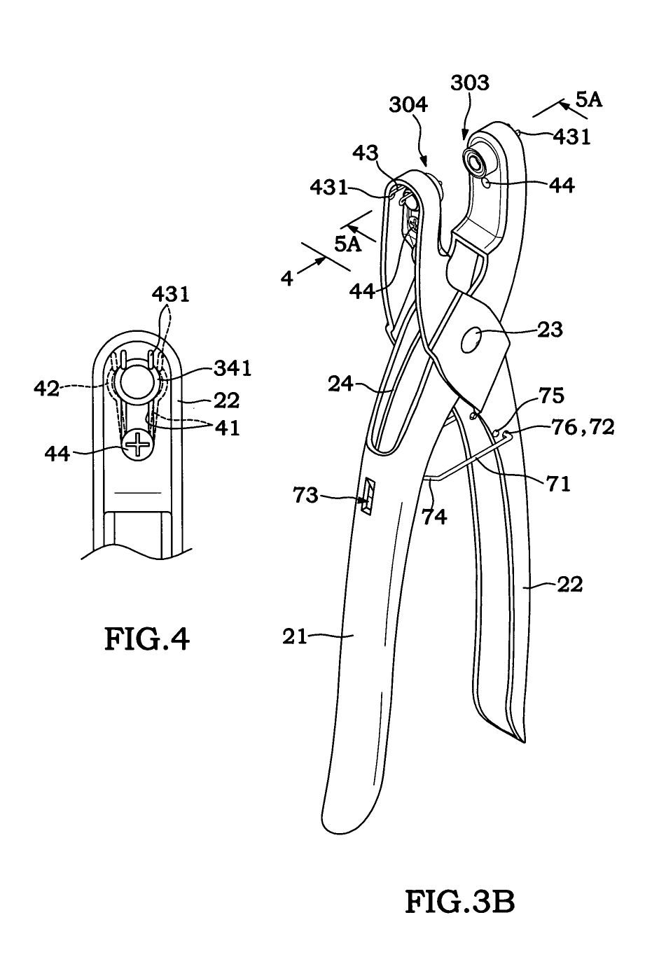

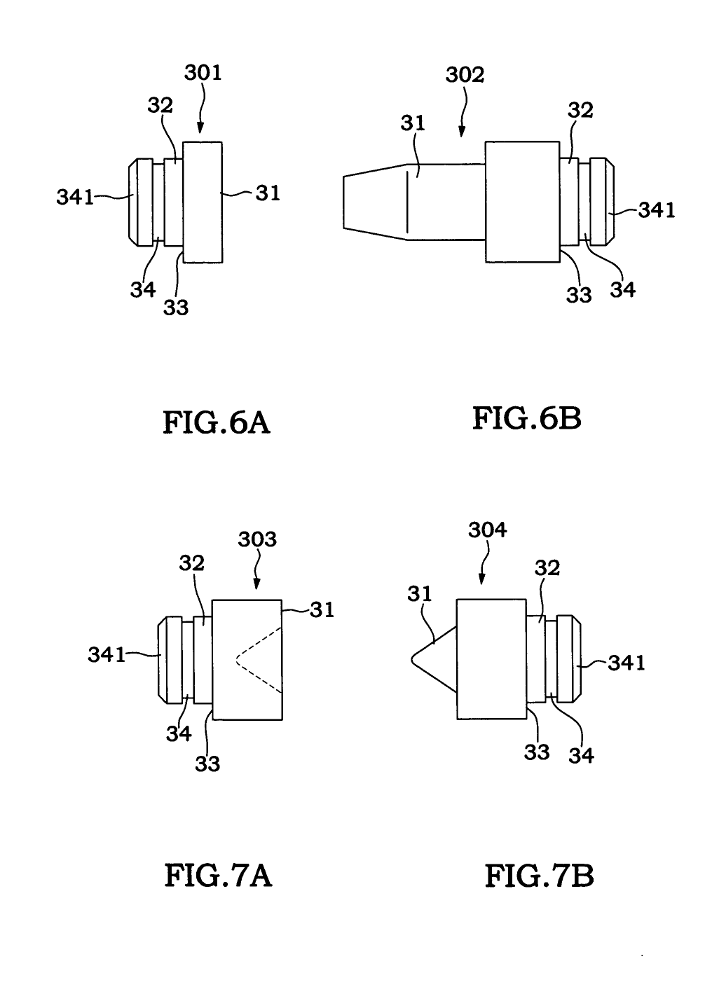

This invention discloses a hole puncher with a quick disassembling structure for replacing cutters, and the hole puncher is made by crossing two tong handles 21, 22 and using a pivotal axis 23 to pass through them, and a torque spring 24 passes through the pivotal axis 23 such that two end pins of the torque spring 24 respectively press against the inner side of the two tong handles 21, 22, and thus a user can control the tong member by gripping or releasing the tong handles 21, 22. The hole puncher works together with a plurality cutters of different sizes and functions. Please refer to FIGS. 6A, 6B, 7A, and 7B for the cutter having an anvil 301, hole cutter 302, tack anvil member 303, and tack clipping member 304. The hole puncher having a quick assembling structure comprises:
an elastic clamp 40 as shown in FIGS. 3A˜5B, being an integrally bent metal bar and forming a fixed section 41 with parallel bars proximate the bent position, and a latch section 42 being further extended outward from the bar in the opposite direction, and a control section 43 being further extended vertically from the latch section 42;
a latch hole 50 as shown in FIG. 3A, disposed at the tip of the tong member 20, for fixing the fixed section 41 of the elastic clamp by a fixture 44 at the backside of the tip of the tong member 20, and the control section 43 being extended to the open end of the tip of the tong member 20 with its end 43 1 protruding out of the tip of the tong member 20;
a working section a cutter hole 60 as shown in FIG. 3A, disposed at the tip of the tong member 20 corresponding to the position of the latch section 42 of the elastic clamp 40;
a working section 31 and a fixed section 32 being disposed on the anvil 301, cutter hole 302, tack anvil member 303, and tack clipping member 304 of the cutter as shown in FIGS. 6A, 6B, 7A, and 7B; wherein the width of the fixed section being smaller than that of the working section 31, such that the interface of two sections defining a blocking surface 33, and the fixed section 32 having a latch groove 34 surrounding the fixed section 32 and the corner of its open end being aslant and serving as a guiding corner 341; when the cutter being inserted into the cutter hole 60 on the corresponding surface of the tip of the tong member 20 by the fixed section 32, such guiding corner 341 being used to guide the fixed section 32 into the spread elastic clamp 40, and the elastic clamp embedding into latch groove 34 by the latch section 42, and thus the cutter being mounted onto the tip of the tong member 20 as shown in FIG. 4; when the cutter being released, a finger being used to press the end 431 of the elastic clamp 40 and a force being gently exerted to open the control section 43 such that the latch section 42 extending outward and releasing the latch groove 34 of the cutter for the user to remove the cutter.

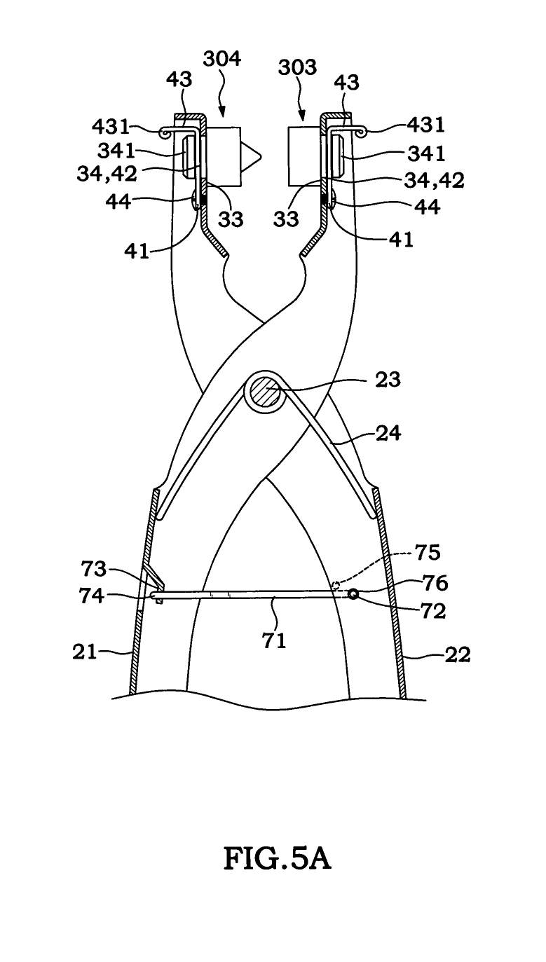

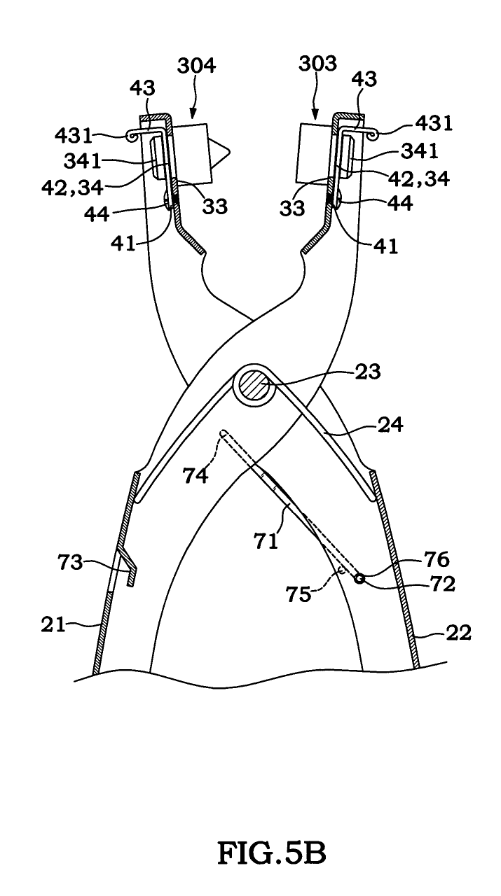

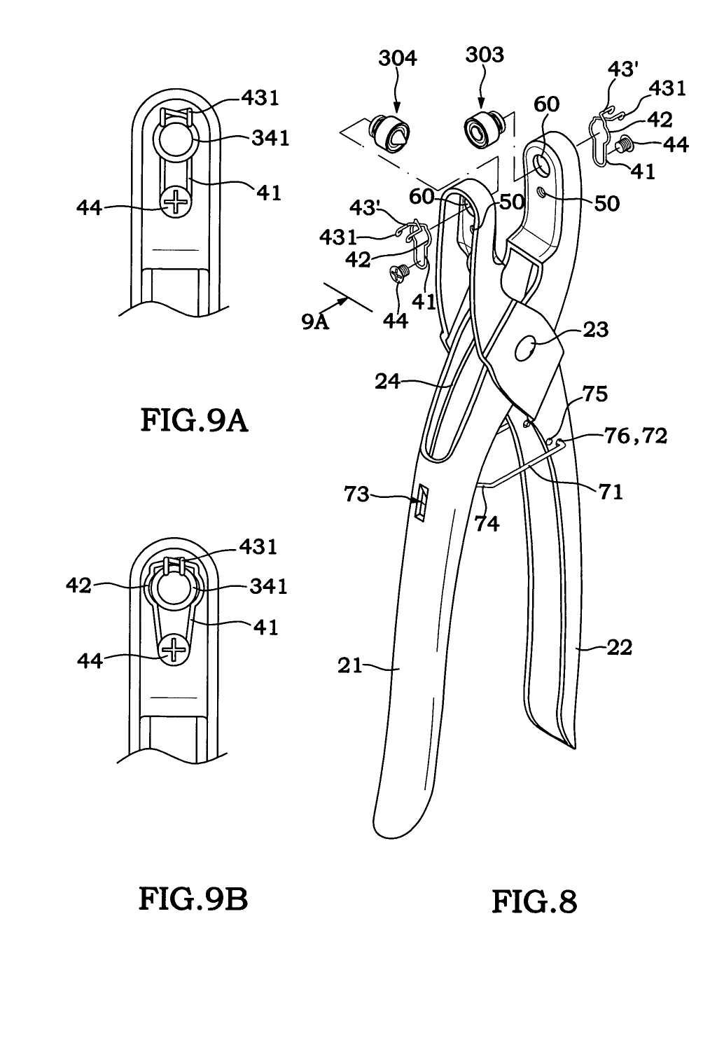

Please refer to FIGS. 8, 9A, and 9B for the hook structure of the hole puncher in accordance with this invention which allows the tong member to open and close. Such hook structure comprises a U-shape hook 71 and its two open hook pins 72 pivotally coupled to a small hole 73 of one of the tong handles such that the U-shape hook 71 being capable of swinging between the two tong handles; a wall hook 73 being disposed on the corresponding position of another tong handle for hooking onto the closed end 74 of the U-shape hook 71 such that the tong member being closed and fixed into its position. On the other hand, the closed end is separated from the wall hook 73, so that the tong member can be elastically opened; a protruded point (75) is disposed on the sidewall of the tong handle adjacent to the two hook pins 72 to prevent the U-shape hook 71 from swinging between the two tong handles that will affect the operation of the tong member. The protruded point 75 blocks the U-shape hook 71 to prevent the U-shape hook from dropping and shaking as shown in FIG. 5B).

This invention makes use of the quick disassembling structure to make the replacement of cutters simpler, easier, and quicker. The cutter can be securely mounted to the elastic clamp 40, so that when the tong member carries out the punching or tacking operation, the clipping force of the tong member makes the blocking section 33 of the cutter to stably press the wall at the tip of the tong in order to have a stable support, and the cutter can then carry out the punching or tacking operation in a stable manner, and thus greatly reducing the probability of producing defects and mistakes.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A hole puncher with quick disassembling structure for changing cutters, having a pair of corresponding extendible tong handles, a plurality of cutters of different sizes and functions, and two quick disassembling structures, each comprising:
an elastic clamp, being an integrally bent metal bar and forming a fixed section with parallel bars proximate the bent position, and a latch section being further extended outward from the bar in the opposite direction, and a control section being further extended vertically from the latch section;
a latch hole, disposed at the tip of the tong member, for fixing the fixed section of the elastic clamp by a fixture at the backside of the tip of the tong member;
a cutter hole, disposed at the tip of the tong member corresponding to the position of the latch section of the elastic clamp;
a fixed section, disposed on the cutter, and having a latch groove surrounding the fixed section such that the fixed section being embedded into the latch hole, and the latch section of the elastic clamp being latched into the latch groove to fix the cutter to the tip of the tong member.

2. The hole puncher with quick disassembling structure for changing cutters of claim 1, wherein said bars of the control section are parallel to each other.

3. The hole puncher with quick disassembling structure for changing cutters of claim 1, wherein said control section has a curling spherical end.

4. The hole puncher with quick disassembling structure for changing cutters of claim 1, wherein said control section of the elastic clamp extends towards the open end of the tip of the tong member and protrudes out of the tip of the tong member.

5. The hole puncher with quick disassembling structure for changing cutters of claim 1, wherein said bars of the control section are crossed with each other.

6. The hole puncher with quick disassembling structure for changing cutters of claim 1, wherein said control section has a curling spherical end.

7. The hole puncher with quick disassembling structure for changing cutters of claim 6, wherein said control section of the elastic clamp extends towards the open end of the tip of the tong member and protrudes out of the tip of the tong member.

8. The hole puncher with quick disassembling structure for changing cutters of claim 1, wherein said fixed section of the cutter has an aslant open end serving as a guiding corner.

9. The hole puncher with quick disassembling structure for changing cutters of claim 1, wherein said fixed section of the cutter has a width smaller than that of the working section, such that said fixed section and working section define a blocking surface.

10. A hole puncher with quick disassembling structure for changing cutters, having a pair of corresponding extendible tong handles, a plurality of cutters of different sizes and functions, and two quick disassembling structures, each comprising:
an elastic clamp, being an integrally bent metal bar and forming a fixed section with parallel bars proximate the bent position, and a latch section being further extended outward from the bar in the opposite direction, and a control section being further extended vertically from the latch section, and the bars of said control section being parallel to each other;
a latch hole, disposed at the tip of the tong member, for fixing the fixed section of the elastic clamp by a fixture at the backside of the tip of the tong member;
a cutter hole, disposed at the tip of the tong member corresponding to the position of the latch section of the elastic clamp;
a fixed section, disposed on the cutter, and having a latch groove surrounding the fixed section such that the fixed section being embedded into the latch hole, and the latch section of the elastic clamp being latched into the latch groove to fix the cutter to the tip of the tong member.

11. The hole puncher with quick disassembling structure for changing cutters of claim 10, wherein said control section has a curling spherical end.

12. The hole puncher with quick disassembling structure for changing cutters of claim 11, wherein said control section of the elastic clamp extends towards the open end of the tip of the tong member and protrudes out of the tip of the tong member.

13. The hole puncher with quick disassembling structure for changing cutters of claim 10, wherein said fixed section of the cutter has an aslant open end serving as a guiding corner.

14. The hole puncher with quick disassembling structure for changing cutters of claim 10, wherein said fixed section of the cutter has a width smaller than that of the working section, such that said fixed section and working section define a blocking surface.

15. A hole puncher with quick disassembling structure for changing cutters, having a pair of corresponding extendible tong handles, a plurality of cutters of different sizes and functions, and two quick disassembling structures, each comprising:
an elastic clamp, being an integrally bent metal bar and forming a fixed section with parallel bars proximate the bent position, and a latch section being further extended outward from the bar in the opposite direction, and a control section being further extended vertically from the latch section, and the bars of said control section being crossed with each other;
a latch hole, disposed at the tip of the tong member, for fixing the fixed section of the elastic clamp by a fixture at the backside of the tip of the tong member;
a cutter hole, disposed at the tip of the tong member corresponding to the position of the latch section of the elastic clamp;
a fixed section, disposed on the cutter, and having a latch groove surrounding the fixed section such that the fixed section being embedded into the latch hole, and the latch section of the elastic clamp being latched into the latch groove to fix the cutter to the tip of the tong member.

16. The hole puncher with quick disassembling structure for changing cutters of claim 15, wherein said control section has a curling spherical end.

17. The hole puncher with quick disassembling structure for changing cutters of claim 16, wherein said control section of the elastic clamp extends towards the open end of the tip of the tong member and protrudes out of the tip of the tong member.

18. The hole puncher with quick disassembling structure for changing cutters of claim 15, wherein said fixed section of the cutter has an aslant open end serving as a guiding corner.

19. The hole puncher with quick disassembling structure for changing cutters of claim 15, wherein said fixed section of the cutter has a width smaller than that of the working section, such that said fixed section and working section define a blocking surface
